(19) United States
(12) Patent Application Publication
(10) Pub. No.: US 2008/0266091 A1
(43) Pub. Date: Oct. 30, 2008

(54) Key locating system

(76) Inventor: Ira John Hill, Cartersville, GA (US)

Correspondence Address: JOHN L. JAMES, P.O. BOX 9839, FLEMING ISLAND, FL, 32006-0035, US

(21) Appl. No.: 11/796,994

(22) Filed: Apr. 30, 2007

(51) Int. Cl. G08B 21/00

(52) U.S. Cl. 340/571

(57) ABSTRACT

A system for locating a key from a vehicle includes a transmitter adapted to mount on the vehicle. An activation switch causes the transmitter to selectively broadcast a signal. A receiver has the key attached thereto and a speaker. The receiver receives the signal from the transmitter and emits a sound from the speaker marking the location of the key.

### TECHNICAL FIELD OF THE INVENTION

This invention relates generally to keys, and, more particularly, to a system for locating lost or misplaced keys.

### BACKGROUND OF THE INVENTION

Keys are very useful for locking and unlocking doors to houses, automobiles, desks, file cabinets and other devices and items. Many people have several keys conveniently bundled on a key ring or other key keeping device. When carried in a pocket of an item of clothing, the bundle of keys can be bulky and cause premature wear of the pocket thereby ruining the clothing garment. When carried in a purse, the bundle of keys is often difficult to locate and retrieve for use. Because of these problems of bulkiness, loss, wear and other problems, keys are often laid down in any convenient place and consequently lost or forgotten. Accordingly, it will be appreciated that it would be highly desirable to have a system for locating lost or misplaced keys.

Automobile keys are particularly troublesome because modern, large-headed keys are bulky thereby inviting laying them down someplace instead of placing them in a pocket or purse. Sometimes, a person drives to a destination and lays down the automobile keys at what later becomes an unknown location. At other times, a person drives to a destination, leaves the keys in the automobile and forgets. In these instances, it would be very helpful to know whether the keys are actually inside the automobile, especially if the automobile doors are locked, to limit or expand the search. Accordingly, it will be appreciated that it would be highly desirable to have a system for locating lost or misplaced keys that quickly determines whether keys are inside an automobile.

### SUMMARY OF THE INVENTION

The present invention is directed to overcoming one or more of the problems set forth above. Briefly summarized, according to one aspect of the present the invention, a system for locating a key from a vehicle, comprises a transmitter adapted to mount on the vehicle and adapted to generate a signal; an antenna coupled to the transmitter for broadcasting the signal within a predetermined radius of the vehicle; an activation switch for causing the transmitter and antenna to selectively broadcast the signal; and a receiver having the key attached thereto and a speaker. The receiver is adapted to receive the signal from the transmitter and emit a sound from the speaker marking the location of the key. Operating the activation switch immediately lets the operator know whether the key is actually inside the automobile.

According to another aspect of the invention, a system for locating a key, comprises a first transmitter having a first activation switch and being adapted to generate a first signal within a predetermined radius of a fixed location; a second transmitter having an antenna and a second activation switch; means for mounting the antenna on a vehicle with the second transmitter being adapted to generate a second signal within a predetermined radius of the vehicle; and a receiver with the key attached thereto and adapted to receive the signals from the first and second transmitters. Operating the second activation switch immediately lets the operator know whether the key is actually inside the automobile, or within the given radius of operation. Operating the first activation switch immediately lets the operator know whether the key is within the given radius of operation of the first transmitter.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a diagram of a wall mounted transmitter unit for a key locating system according to the present invention.

FIG. 2 is a rear view of a key fob for the key locating system FIG. 1.

FIG. 3 is a front view of the key fob of FIG. 2.

FIG. 4 is a diagram of a vehicle with a vehicle mounted transmitter unit for a key locating system for use with the keys fob of FIGS. 2-3.

### DETAILED DESCRIPTION OF THE PREFERRED EMBODIMENTS

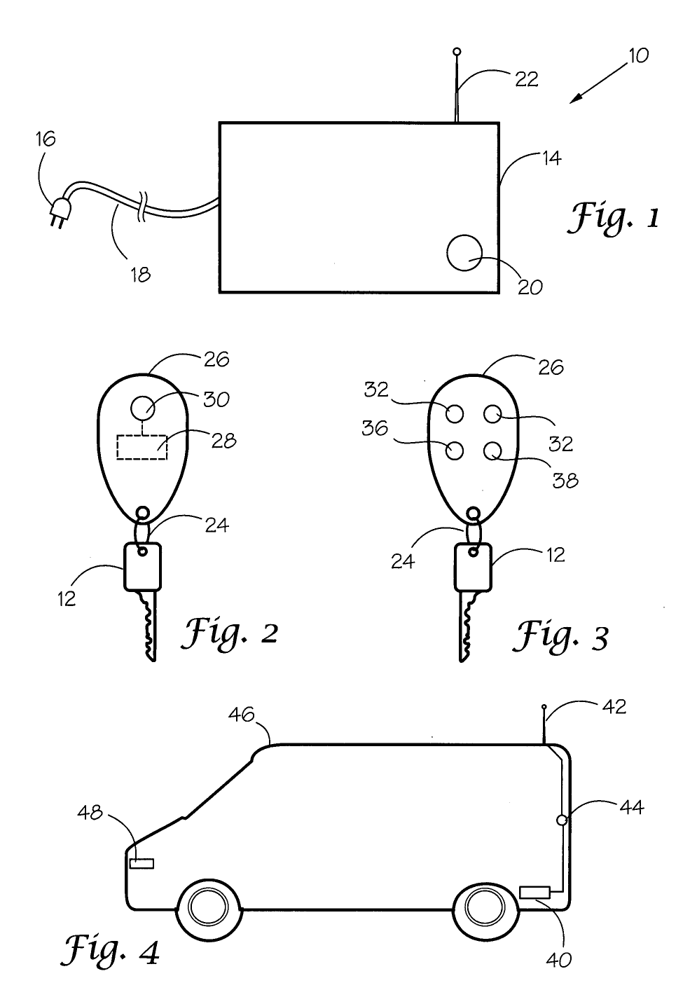

Referring to FIGS. 1-4, a key locating system 10 locates a key 12 using a receiver and one or two transmitters. A first transmitter 14 is adapted to generate a first signal within a predetermined radius of a fixed location. Transmitter 14 is the base or home transmitter located in the home of the user for locating a key misplaced at home. Because transmitter 14 is in the home, it can be powered by inserting plug 16 it into a standard electrical wall outlet to convey power via power cord 18 so that it is always ready to be used. Plug 16 and cord 18 form a means for supplying electrical energy to the first transmitter 14. The first transmitter 14 is used by operating a first activation switch, such as pushbutton switch 20, preferably causing antenna 22 to broadcast a signal. The signal preferably has a range of 150 feet or so and is broadcast until stopped by depressing pushbutton 20 again.

Referring to FIGS. 2-3, key 12 is attached via key ring 24 to a key fob 26 which incorporates a receiver 28 for the signal from base transmitter 14. When the transmitted signal is received by receiver 26, it is made audible by speaker 30. When key fob 26 is an automotive key fob, it has the usual buttons such as button 32 for locking, button 34 for unlocking, button 36 for opening the trunk and a panic button 38.

Referring to FIG. 4, a second transmitter unit 40 has an antenna 42 and a second activation switch 44 and is adapted to mount or install on a vehicle 46. Unit 40 is preferably mounted in space existing inside the vehicle, such as the wheel well area, spare tire compartment, tool compartment, rear quarter panel or other area where it is out of the way. Transmitter 40 preferably receives power from the vehicle battery 48 mounted under the hood via the vehicle wiring harness, or through appropriate wiring when installed as an after-market item. The second transmitter 40 is adapted to generate a second signal within a predetermined radius of vehicle 46 via antenna 42. Antenna 42 may be mounted on a window, roof or side panel of the vehicle, or may be on transmitter 40 when it is disposed in a location conducive to radio frequency or other transmissions. Preferably, transmitter 40 broadcasts within a radius of 150 feet or so.

Receiver 28 is adapted to receive the signals from the first and second transmitters 14, 40 which may be the same or different. When different, the sound emitted by speaker 30 may differ for each transmitter.

It can now be appreciated that a system for locating a lost or misplaced key has been presented. The system includes at least one transmitter and a receiver attached to the lost or misplaced key. The system may also include a second transmitter so that deployed transmitters can be deployed at home as a base station, and on a vehicle as a mobile station.

While the invention has been described with particular reference to the preferred embodiments, it will be understood by those skilled in the art that various changes may be made and equivalents may be substituted for elements of the preferred embodiments without departing from invention. For example, while it is contemplated that the base transmitter station will be operated using standard house current, a battery can be used for powering the unit. Similarly, while it is contemplated that the vehicle transmitter will be operated using the vehicle battery, a disposable battery can be used.

As is evident from the foregoing description, certain aspects of the invention are not limited to the particular details of the examples illustrated, and it is therefore contemplated that other modifications and applications will occur to those skilled in the art. For example, the activation switch may be a magnetic switch that closes a circuit when a magnet is passed near it. Such a switch could be disposed inside the vehicle and operated by the magnet from outside the vehicle without compromising the integrity of the vehicle. Such a magnetic switch would be useful for after-market applications. It is accordingly intended that the claims shall cover all such modifications and applications as do not depart from the true spirit and scope of the invention.

### ELEMENT LIST

10 key locating system
12 key
14 first transmitter
16 plug
18 power cord
16, 18 means for supplying electrical energy
20 first activation switch
22 antenna
24 key ring
26 key fob
28 receiver
30 speaker
32 button for locking
34 button for unlocking
36 button for opening the trunk
38 panic button
40 second transmitter unit
42 antenna
44 second activation switch
46 vehicle
48 vehicle battery

What is claimed is:

1. A system for locating a key from a vehicle, comprising:
a transmitter adapted to mount on the vehicle and adapted to generate a signal;
an antenna coupled to said transmitter for broadcasting said signal within a predetermined radius of the vehicle;
an activation switch for causing said transmitter and antenna to selectively broadcast said signal;
means for supplying electrical energy to said transmitter; and
a receiver having a speaker, said receiver being adapted to receive said signal from said transmitter and emit a sound from said speaker, said receiver having the key attached thereto.

2. A system, as set forth in claim 1, wherein said receiver is incorporated into a key fob.

3. A system, as set forth in claim 1, wherein said means for supplying electrical energy to said transmitter includes a battery.

4. A system, as set forth in claim 1, wherein said activation switch is a magnetic switch.

5. A system, as set forth in claim 1, wherein the predetermined radius is about one hundred fifty feet.

6. A system for locating a key, comprising:
a first transmitter adapted to generate a first signal within a predetermined radius of a fixed location, said first transmitter having a first activation switch;
means for supplying electrical energy to said first transmitter;
a second transmitter having an antenna and a second activation switch;
means for mounting said antenna on a vehicle, said second transmitter being adapted to generate a second signal within a predetermined radius of the vehicle; and
a receiver adapted to receive said signals from said first and second transmitters, said receiver having the key attached thereto.

7. A system, as set forth in claim 6, wherein said receiver is incorporated into a key fob.
